(19) United States
(12) Patent Application Publication
(10) Pub. No.: US 2007/0261470 A1
(43) Pub. Date: Nov. 15, 2007

(54) Oxygen Sensor And A Method Utilising It

(75) Inventors: Henning Jensen, Frederiksberg (DK); Poul Fogh, Slagelse (DK); Elvin Schmidt Solberg, Vordingborg (DK); Kenneth Hansen, Fjenneslev (DK)

Correspondence Address: BACON & THOMAS, PLLC, 625 SLATERS LANE, FOURTH FLOOR, ALEXANDRIA, VA, 22314, US

(73) Assignee: PBI-DANSENSOR A/S, DK-4100 RINGSED (DK)

(21) Appl. No.: 11/664,596

(22) PCT Filed: Oct. 6, 2005
(86) PCT No.: PCT/DK05/00643

§ 371 Date: Apr. 4, 2007

(30) Foreign Application Priority Data
Oct. 6, 2004 (DK) PA 2004 01527

(51) Int. Cl. G01N 25/00

(52) U.S. Cl. 73/23.2

(57) ABSTRACT

Use of an oxygen sensor comprising a membrane, preferably in the form of a first tube (2), which is substantially made of zirconium dioxide and has an internal and an external coating (3, 4) of an electrically conductive, catalytic layer. On the electrically conductive, catalytic layer, a porous, preferably ceramic layer (5) is provided. The porous layer (5) is provided on the electrically conductive, catalytic layer (3), which is located at least partially within a second tube (6), made of a gas tight material. The oxygen sensor, which is part of a clamped together structure with O-rings, may be used in a method, in which the measuring gas, especially a reactive measuring gas, is supplied to the external side of the first tube (2).

The present invention relates to the use of an oxygen sensor comprising a membrane, substantially made of stabilized zirconium dioxide, the two respective sides of the membrane having a first and a second electrically conductive, catalytic coating. Furthermore, the invention relates to a method for measuring oxygen content in a gas and an oxygen sensor comprising a membrane in the form of a first tube, which is substantially made of stabilized zirconium dioxide, and which is located, at least partially, within a second tube, made of a gas tight material, the first tube having a first electrically conductive, catalytic coating on the internal side of the tube and a second electrically conductive, catalytic coating on the external side of the tube, a porous, preferably ceramic coating being provided on the external electrically conductive, catalytic coating.

Such an oxygen sensor for measuring technical gases is known, for example, from PBI-Dansensor A/S, Ringsted, DK.

This known oxygen sensor, which has been on the market for more than twenty years, comprises a ceramic tube of stabilized zirconium dioxide (ZrO₂), an technical gas being supplied to the internal side of the tube as a test gas and a reference gas being supplied to the external side of the tube. On both the internal side of the tube and on its external side, a platinum coating of metallic platinum (Pt) is applied. When the tube is heated to approximately 1000 K, the platinum coating functions as a catalyst and splits oxygen molecules O₂ into negative oxygen ions. At the stated 1000 K, the ceramic tube of ZrO₂ is permeable to these oxygen ions and thus constitute an ion-permeable membrane, so that a measurable electric current occurs between the two platinum coatings, which is an expression of the diffusion of ions through the stabilized ZrO₂ constituting the wall of the tube, and thus an expression of the difference in the oxygen partial pressure between the test gas and the reference gas.

In connection with this known oxygen sensor, it has been known for long that the problem occasionally arises that certain technical gases, at least at the said 1000 K, are reactive and attack the platinum coating, so that this, in the worst case, is destroyed. An example of such an technical gas is the protection gas, which, in industrial processes such as soldering, is used to protect against the oxygen in the air during the soldering, and the oxygen content of which is therefore monitored on a continuous basis. In this case, contaminations originating from the soldering process occur, which may be detrimental to the oxygen sensor. Another example of such an technical gas is the packaging of, for example, foodstuff in a modified atmosphere free of oxygen, which is monitored during the packaging. For example, in connection with roasted and ground coffee, organic residual products may occur, which destroy the oxygen sensor. Throughout the years, the traditional approach to the latter problem has been to expose the sensor to oxygen, in order to thus burn off the organic residual products, so as to prolong the life of the sensor. Another approach used throughout the years in connection with both the soldering gases and the organic residual products in the modified atmosphere in packages has been to filter the technical gases through activated carbon in order to remove the contaminations.

Another technical area in which oxygen sensors are used is Otto engines in automobiles with catalytic converters. In modern Otto engines, petrol and atmospheric air must be mixed in a stoichiometric ratio, yielding a complete combustion so that after the combustion no O₂ is left in the combustion gases. In order to control the mixture, the combustion gases are monitored with an oxygen sensor placed in the exhaust in front of the catalytic converter. Here, when constructing the oxygen sensor, in many cases, ceramic coatings have been used on top of the platinum electrode, which is exposed to the hot combustion gases. See, for example, U.S. Pat. No. 5,435,901, U.S. Pat. No. 4,021,326, U.S. Pat. No. 5,486,279, DE-A-3628572, U.S. Pat. No. 4,121,988, U.S. Pat. No. 5,766,434.

On this background, the object of the invention is to provide an oxygen sensor of the type mentioned in the introduction for measuring technical gases, in which the platinum coating is not attacked and destroyed by reactive technical test gases.

According to a first aspect of the invention, this object is achieved by the use of an oxygen sensor of the type mentioned in the introduction, which is characterized in that a porous, preferably ceramic coating is provided on at least one of the electrically conductive, catalytic coatings.

Such a porous, preferably ceramic coating has turned out to be sufficient to protect the electrically conductive, catalytic coating, in connection with the said technical gases, even though the coating is porous.

According to another aspect of the invention, the object is achieved by means of an oxygen sensor of the type mentioned in the introduction, which is characterized in that the first and the second tube are cylindrical and are retained by a row of clamped together blocks and sealing o-rings, at least one first block having a through bore with a diameter, substantially corresponding to the outside diameter of the first tube, at least one second block having a bore with a diameter, substantially corresponding to the outside diameter of the second tube, and a third block having a through bore with varied diameter, i.e. a first diameter, substantially corresponding to the outside diameter of the first tube, at one end, a second diameter, substantially corresponding to the outside diameter of the second tube, at the second end, and a third diameter with a size in between the first diameter and the second diameter between the first and the other end, and the bores having small diameter increases at the respective faces facing an adjacent block, and o-rings being inserted in the cavity, which exists between a tube in question and two adjacent blocks due to the diameter increase of the bores.

According to a third aspect of the invention, the oxygen sensor is used for measuring oxygen content in a gas.

According to a particularly preferred embodiment of the, the oxygen sensor comprises a first tube, comprising the membrane, the first and the second electrically conductive, catalytic coating, respectively, being an internal and an external coating, and a porous, preferably, ceramic coating being provided on the external electrically conductive, catalytic coating.

Such a structure with a tube allows for a reduction in the tightness problems existing in such a zirconium based oxygen sensor, in a simple manner.

According to a preferred embodiment of the use of the invention, the porous coating is provided on the electrically conductive, catalytic coating, which is located on the external side of the first tube.

For practical reasons, it turns out to be highly preferable to provide the porous, preferably ceramic coating on the external side of the first tube, since it is thereby possible to use, e.g., sputtering or plasma spraying as a process to apply the coating.

However, the use of the protective coating on the external side of the tube entails that it has to be this external side which is brought into contact with the test gas, which is the reactive gas that the electrically conductive, catalytic coating needs to be protected against.

According to a particularly preferred embodiment of the use, the oxygen sensor is therefore formed in such a manner that the first tube is located, at least partially, within a second tube, made of a gas tight material.

Thus, it becomes possible to supply the test gas under controlled conditions. This primarily means without it being contaminated by the surrounding atmospheric air or other unwanted contaminants such as the reference gas.

Consequently, the oxygen sensor of the invention according to yet another preferred embodiment of the use is arranged so that the test gas is supplied to the gap between the first tube and the second tube, whereas the reference gas is supplied to the inner cavity of the first tube.

According to yet another preferred embodiment of the use, the first tube terminates in a gas tight closed end formed integrally with the rest of the tube, and this gas tight closed end is located within the second tube.

By terminating the tube in such a gas tight closed end, possible sealing problems at this end are avoided.

According to a further preferred embodiment of the use of the invention, the electrically conductive, catalytic coating is chosen among the group comprising the noble metals Au, Ag and Pt and electrically conductive oxides of rare earths.

These materials are preferred, because they either do not have oxides, which might give off oxygen ions that would affect the measuring result, or they do not emit such oxygen ions.

According to a preferred embodiment of the invention, the second tube is made of gas tight ceramics.

This material has the suitable thermal properties for use at the stated temperatures, and may, if desired, be used directly as a carrier for an electric heating element.

According to a preferred embodiment of the oxygen sensor, the third block comprises three cylindrical bore sections, each with their own respective diameter.

This offers a good opportunity for retaining the two tubes in well-defined positions, whilst they are sealed, and whilst a chamber for the discharge of the test gas is provided at the end of the second tube.

According to yet another preferred embodiment of the invention, between the third block and the first block and/or the second block, a fourth block is inserted, which has a through bore with diameter increases, preferably chamfers, at both the faces facing the adjacent blocks, and in the respective cavities, which exist due to the diameter increase of the bores between a tube in question, the fourth block and the two adjacent blocks, o-rings are inserted, and in the internal face of the bore of the fourth block, facing the first or the second tube, at least one circumferential groove is provided.

This circumferential groove with seals on both sides enables the penetration of undesired gases to be prevented even further.

In a particularly efficient manner, this is achieved with channels for a flushing gas leading to the circumferential grooves.

Thus, it is possible to dispose of any undesired gas, which may penetrate between the seals.

Preferably, in one embodiment hereof, at least a part of the test gas is used as flushing gas, after the gas has passed the gap between the first and the second tube.

Thus, a circuit for a separate flushing gas is avoided, whilst at the same time ensuring that the flushing gas cannot affect the measuring result by possibly penetrating from the circumferential groove and thus contaminating the test gas. However, use of a separate circuit is not inconceivable, because it would thus be possible to ensure that the flushing gas is not reactive, but this would entail the disadvantage of needing to monitor its composition in order to ensure that the above contamination is avoided.

In a preferred embodiment of the method of the invention, the test gas is supplied to the external side of the first tube.

The invention will now be described in more detail based on examples of embodiments and with reference to the drawings, in which

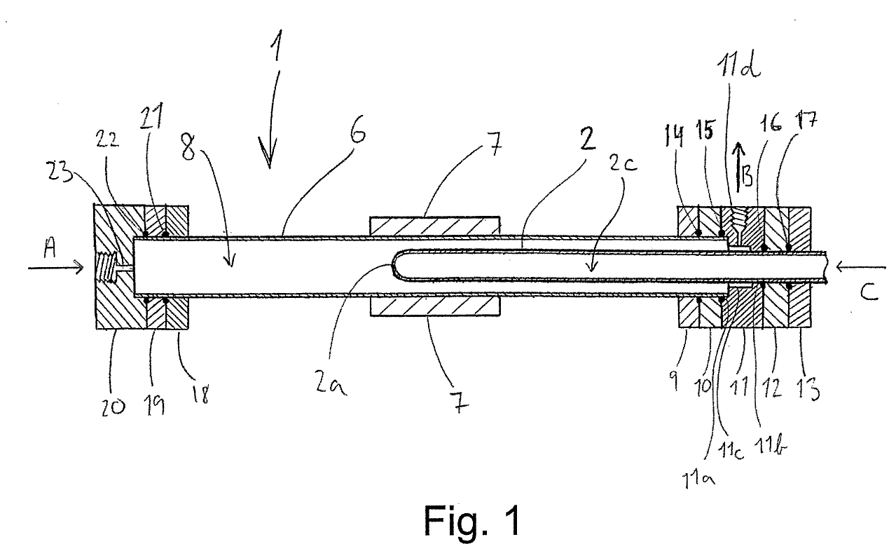

FIG. 1 schematically shows a section through a first embodiment of the oxygen sensor according to the invention,

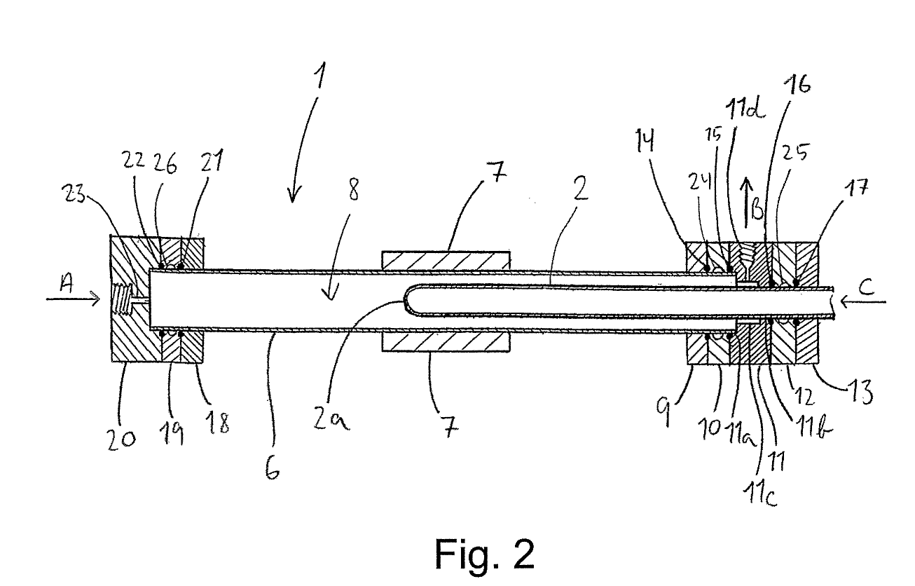

FIG. 2 schematically shows a section through another embodiment of the oxygen sensor according to the invention, and

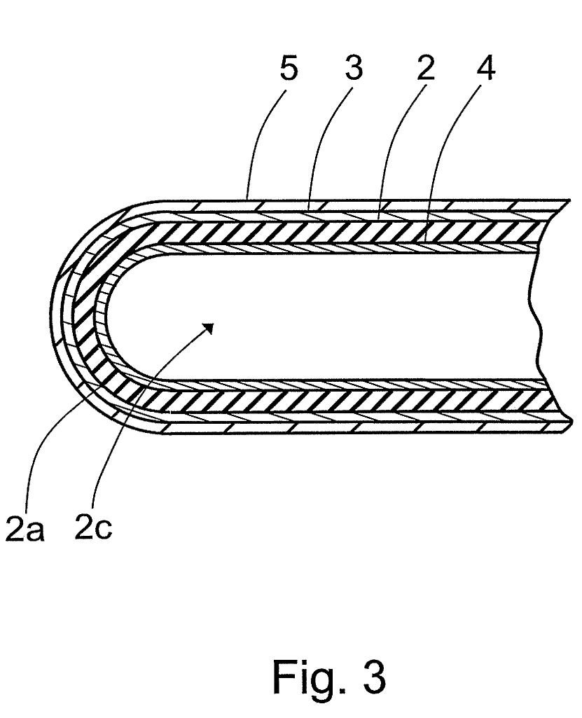

FIG. 3 schematically shows a section through the outer end of the inner tube of the oxygen sensor.

The two embodiments have a large number of common features, and therefore, in the following, like references will be used for corresponding parts of the two embodiments.

FIG. 1 schematically shows a section through an oxygen sensor 1 according to the invention. The oxygen sensor comprises a membrane in the form of a first tube 2. The first tube 2 is substantially made of stabilized zirconium dioxide, ZrO₂. The first tube 2 is preferably cylindrical, but terminates in a gas tight closed end 2a formed integrally with the rest of the tube, whereas the other end, not shown, is open. The first tube 2 is placed so that at least part of it extends within a second tube 6, which is also preferably cylindrical. Preferably, the first tube 2 is placed concentrically with the second tube 6, as shown in FIGS. 1 and 2, i.e. so that the open end of the first tube is located outside the second tube 6, whereas the closed end 2a is located approximately halfway into the second tube 6. The second tube 6 is made of a gas tight, heat resistant material, preferably alumina, Al₂O₃.

Around the middle part of the second tube 6, approximately at the position, in which the closed end 2a of the first tube 2 is located, a heating element 7 is placed. This heating element 7 is capable of heating the first tube 2 and the second tube 6 to a temperature in the interval from approximately 200 K to approximately 1000 K, at least in an area around the closed end 2a of the first tube 2. Normally, this area will be encapsulated in a block, not shown, of heat insulating, heat resistant material. In view of the ion permeability, it is advantageous to heat the area to as high a temperature as possible, and in certain cases also higher than the said 1000 K. However, at higher temperatures, the problem will arise that the stabilized zirconium dioxide resinters whereby its permeability properties changes.

At both ends of the second tube 6, sealing arrangements are provided, so that a gap is provided which is gas tight in relation to the surroundings, and which serves as measuring chamber 8, between the first tube 2 and the second tube 6.

In the preferred embodiment shown in FIG. 1, these sealing arrangements comprise a row of blocks, preferably in the form of disks, and o-rings. The disks are preferably made of metal, for example stainless steel or aluminium, and the o-rings are preferably made of a suitable deformable material. For example, the o-rings could be made of rubber, but they could also be rolled, of the type with inert atmosphere rolled into an o-ring of silver or indium. A person skilled in the art will appreciate that the disks may be clamped together in numerous different manners, for example with bolts, not shown, positioned in parallel to the longitudinal axes of the first tube 2 and the second tube 6.

In both of the two embodiments shown, the sealing arrangements comprise two sealing arrangements, i.e. a first sealing arrangement at one end, where the first tube 2 extends out of the second tube 6, comprising a row of disks 9, 10, 11, 12, 13, i.e. in the present case five disks, and four o-rings 14, 15, 16, 18. At the other end, where the second tube 6 terminates in the second sealing arrangement, this comprises a row of disks, 18, 19, 20, i.e. three disks in total, and two o-rings 21, 22.

More particularly, the first sealing arrangement from the right to the left in FIGS. 1 and 2 comprises a first disk 9 with a central bore, which substantially has a diameter corresponding to the outside diameter of the second tube 6. However, the bore of the disk 9 comprises a smaller diameter increase, for example in the form of a chamfer, at the face facing the adjacent disk 10. Similarly, the disk 10 has a central bore, which substantially has a diameter corresponding to the outside diameter of the second tube 6. However, the bore of the disk 10 comprises smaller diameter increases, for example in the form of chamfers, at both the faces facing adjacent disks. I.e. the previously mentioned disk 9 and the next disk 11 in the row. In the cavity provided between the second tube 6 and the disks 9 and 10 due to the diameter increases, a sealing o-ring 14 is inserted.

The next disk 11 in the row has a bore with varying diameter, i.e. from a first diameter, corresponding to the diameter of the second tube 6, at the face adjoining the previously mentioned adjacent disk 10, to a diameter corresponding to the first tube 2, at the face facing the next disk 12 in the row. Between these two diameters, the disk 11 has a transition area 11c, in which the diameter is in between the diameters of the first tube 2 and the second tube 6. Preferably, the bore is stepped so that it consists of three cylindrical sections 11a, 11b, 11c each with their own diameter. However, this does not prevent especially the transition area 11c from having a continuously variable diameter, for example frusto conical. Also the bores 11a, 11b of this disk 11 have slight enlargements at the end faces of the disk, so that, together with the adjacent disks 10, 12, annular cavities are formed, in which sealing o-rings 15, 16 are inserted.

In addition, the transition area 11c serves as discharge channel from the measuring chamber, and therefore it has a preferably radial bore 11d, which may be connected to a discharge conduit, not shown. Preferably, the radial bore has a thread for screwing on the discharge conduit. It will be obvious to a person skilled in the art that, instead of radially, the bore may be placed differently, for example as a chord or tangentially in relation to the diameter of the transition area 11c.

In principle, the last two disks 12 and 13 are not different from the disks 9 and 10, except from the fact that the bores of the disks 12 and 13 have a diameter, which is adapted to the first tube 2, and thus smaller than the bores of the disks 9 and 10.

The second sealing arrangement at the other end of the second tube 6 comprises, from the left to the right, three blocks, preferably in the form of disks 18, 19, 20. All these three disks 18, 19, 20 have central bores, with diameters corresponding to the outside diameter of the second tube 6. Since this end requires similar sealing of the second tube 6 in relation to the surroundings as in the case of the first end, the disk 18 may, in principle, be formed identically to the disk 9, and the disk 19 may, in principle, be formed identically to the disk 10. Thus, between the disks 9 and 10, a sealing o-ring 21 may also be inserted. Contrary to this, the disk 20 is different in that the bore is not a through bore, but has a bottom terminating the second tube 6 in a sealing manner in relation to the surroundings, thus providing the above measuring chamber 9. At the disk 20, the discharge of the bore is also slightly enlarged, thus providing room for a seal in the form of an o-ring 22 between this disk 20 and the adjacent disk 19.

For supplying test gas to the measuring chamber, a channel 23 is provided. Part of the channel 23 is internally threaded for connection to a supply pipe, not shown, for test gas. The connection could also be formed as a flange transition with an o-ring. This would offer the advantage of the seal being brought closer to the measurement chamber, so that no pockets occur in the thread, for example, where contamination would be likely to accumulate. In the embodiment shown, the channel 23 is placed coaxially with the bore. A person skilled in the art will appreciate that the channel 23 might just as well be placed radially, as a chord or tangentially in relation to the bore, like the discharge channel 11d of the disk 11 is placed in relation to the bore 11c.

By providing the sealing arrangements as stacks of disks, it becomes very easy to place the multiple seals in the form of the o-rings 14, 15; 16, 17; 21, 22 around the first tube 2 and the second tube 6, since the o-rings may be placed individually as single members around the first tube 2 or the second tube 6 and thus do not have to be positioned in respective internal grooves in a block first and then be slid onto the respective tube 2, 6 together with the block.

For a better understanding of the following description of the function of the oxygen sensor, a short description of the first tube 2 and its special protection layer 5 of the invention will first of all be presented, with reference to FIG. 3.

In FIG. 3, the closed end of 2a of the first tube 2 is shown. As mentioned, the first tube 2 consists substantially of stabilized zirconium dioxide ZrO₂. On the external side of the first tube 2, a coating of, or comprising, an electrically conductive, catalytic material 3 is provided. The electrically conductive, catalytic material is preferably metallic platinum, Pt. However, other noble metals may be used, i.e. metals which do not form oxides, for example gold, Au or silver, Ag. In addition, nonmetals such as electrically conductive oxides of rare earths, for example LaₓSr_{y}MnO₄, may be used.

Correspondingly, also on the internal side of the first tube 2, a coating 4 of or comprising an electrically conductive, catalytic material is provided. The electrically conductive, catalytic material is the same as on the external side of the tube 2.

Outermost, on top of the electrically conductive, catalytic material 3, a porous protection layer 5 is provided. Preferably, this protection layer 5 consists of a ceramic material, for example Al₂O₃, MgO or a mixture of the two. This porous protection layer 5 allows the test gas to pass, so that it comes into contact with the electrically conductive, catalytic layer 3 on the external side of the first tube.

The function of the oxygen sensor will now be described.

Via the channel 23 of the disk 20, a test gas is supplied to the measurement chamber 8, as indicated by the arrow A. Preferably, the gas is supplied continuously, so that it enters the measurement chamber 8 at one end of the second tube 6, passes through the second tube 6 and leaves the second tube through the transition area 11c and the channel 11d of the tube 11.

To the cavity 2c of the first tube 2, a reference gas with a known composition, for example atmospheric air, is supplied, as indicated by the arrow C. Since the first tube 2 is closed in one end 2a, preferably no noteworthy gas flow takes place in the first tube 2.

On the external side of the second tube 5, a heating element 7 is provided. In the present embodiment, this is an electric heating element, but other types of heating elements may also possibly be used. The heating element 7 has a suitable power for it to heat the second tube 6 and the first tube 2, which are located within it, to a temperature of 1000 K or more. This heating substantially only takes place in a zone around the closed end of the first tube 2, i.e. corresponding to the part of the longitudinal extent of the second tube where the heating element 7 is located. Other parts of particularly the second tube 6 are only heated to a limited extend, so that, typically, the temperature will be approximately 335 K at the sealing arrangements.

In order to achieve a temperature of 1000 K, the heating element 7 and the second tube 6 will typically be encapsulated in an insulating block, not shown, of heat insulating and heat resistant material.

At 1000 K, the platinum coatings 3, 4 have the required catalytic effect on oxygen molecules, O₂, where the platinum coatings split the oxygen molecules into two negative oxygen ions. Notwithstanding the fact that the stabilized zirconium dioxide, of which the first tube 2 consists, is gas tight, it is permeable to these oxygen ions. Therefore, oxygen diffusion occurs between the external side of the first tube 2 and the internal side. The direction and size of this diffusion depends on the difference between the respective oxygen partial pressures on the external side of the first tube 2 and the internal side of the first tube 2. It should be stressed that the expression membrane must be interpreted broadly in relation to the required permeability. The expression must not be interpreted as implying a given thickness, form or flexibility.

It should be stressed that the expression catalytic in this connection must not be interpreted generally as any catalytic effect, but only in relation to the catalytic effect required for measuring oxygen content, i.e. for the splitting of oxygen molecules into negative oxygen ions.

The diffusion of oxygen ions gives rise to a measurable electric current between the two electrically conductive platinum surfaces 3, 4. Thus, this current is an expression of the difference in oxygen partial pressure and thus for the oxygen content of the test gas in relation to the known oxygen content in the reference gas. The measurement of the electric current, including the wire connection, and its translation into a concrete value for the difference in oxygen partial pressure, or an absolute value for oxygen content in the test gas, is known per se and is not regarded relevant to the present invention, which is directed at the protection of platinum coatings, or similar electrically conductive, catalytic coatings, against destruction caused by reactive test gases, as well as the structural aspects of the structure of the oxygen sensor resulting from the use of this protection.

Primarily, the present invention is seen in the utilization of the knowledge that even with a porous protection layer 5 it is possible to protect the platinum coating in contact with reactive test gases, and, secondly, in presenting a constructive solution allowing such a protection layer to be used in a simple manner in practice.

Notwithstanding the fact that a structure of sealing arrangements with double seals 14, 15; 16, 17; 21, 22, is preferred, it will be obvious to a person skilled in the art that in the cases where the tightness is less important to the measurement, only single seals may be used. In such cases, in the first sealing arrangement, only disks corresponding to the disks 9, 11 and 13 are required and only two o-rings 14 or 15 and 16 or 17, just as in the second sealing arrangement, only the disks 18 and 20 are required as well as one of the o-rings 21 or 22. When required, the disks may be made thicker, i.e. longer in the axial direction, for example in order to be able to retain the respective tube 2, 6 in a better way.

However, there may also be a need for even better sealing against undesired gases than what can be achieved with the sealing arrangements of FIG. 1.

FIG. 2 shows preferred embodiments of such better sealing arrangements. In these embodiments, in the disks 10, 12 and 19, located between the respective pair of o-rings 14, 15; 16, 17 and 21, 22, circumferential channels in the form of grooves 24, 25, 26 are provided in the inner surfaces of the bores. Via channels, not shown, these are connected to a supply of gas corresponding to the gas, which the seals have to protect from contamination. It thus becomes possible to flush any penetrating undesired gas away, before it penetrates into the measurement chamber 8 or into the reference gas in the cavity 2c of the first tube 2.

As for the test gas, it has turned out to be advantageous to use the heated test gas leaving the measurement chamber 8 via the channel 11d. First of all, this limits the consumption of test gas, secondly the measurement itself is not affected by it, as this part of the test gas has passed the measurement chamber.

The embodiments of the oxygen sensor described above may be used in a method for measuring oxygen content in a gas, and particularly in a reactive gas, which is capable of destroying the catalytic coating on the zirconium dioxide tube. Use of the preferred embodiments of the invention described above, where the protection coating 5 is provided externally on the zirconium dioxide tube, i.e. the first tube 2, implies use of a method, in which the test gas, particularly a reactive test gas, is supplied to the external side of the first tube 2, contrary to prior art, in which the test gas was supplied to the inside of the zirconium dioxide tube.

Notwithstanding the fact that the sealing arrangements described are described in relation to their use in an oxygen sensor, a person skilled in the art would appreciate that they may also be used in other connections, where sealing termination and/or retainment of a single tube or more coaxial tubes is required.

Notwithstanding the fact that the present invention has been exemplified within the framework of an oxygen sensor with a tubular zirconium dioxide membrane, a person skilled in the art will appreciate the fact that the form of the membrane is not determining for the knowledge that the catalytic coating may be protected by a porous coating, and therefore other membrane designs than the one illustrated are conceivable. In particular, a person skilled in the art will appreciate the fact that the membrane may be a flat membrane, separating a chamber, for example a tube, into two parts, the membrane, for example, being positioned longitudinally or transversely in relation to the longitudinal direction of the tube. In addition, a person skilled in the art would see that the first tube, instead of being terminated, may be through-going from one sealing arrangement to the other, and either be terminated in a sealing manner in connection with the second sealing arrangement, or terminated with a lead-trough through it, so that the reference gas is able to flow through the oxygen sensor.

1-17. (canceled)

18. The use of an oxygen sensor for measuring oxygen content in soldering gases containing reactive contaminants,
said oxygen sensor comprising a membrane substantially made of stabilized zirconium dioxide in the shape of a first tube and located at least partially within a second tube,
said membrane having a first internal side and a second external side, said first and second sides of the membrane having a respective first and a second electrically conductive, catalytic coating,
wherein a porous, preferably ceramic coating is provided outermost, on top of at least one of the electrically conductive, catalytic coatings.

19. The use according to claim 18, wherein said porous, preferably, ceramic coating is provided on the electrically conductive, catalytic coating on said second external side of the membrane.

20. The use according to claim 19, wherein said second tube is made of a gas tight material.

21. The use according to claim 20, wherein the second tube is made of gas tight ceramics.

22. The use according to claim 21, wherein the first tube terminates in a gas tight closed end formed integrally with the rest of the tube, so as to form an internal cavity in said first tube, and in that this gas tight closed end is located within the second tube.

23. The use according to claims 21 or 22, wherein the oxygen sensor is arranged so that the test gas is supplied to a gap between the first tube and the second tube, whereas the reference gas is supplied to said internal cavity of the first tube.

24. The use according to claim 18, wherein the electrically conductive, catalytic coating is selected among the group comprising the noble metals Au, Ag and Pt and electrically conductive oxides of rare earths.

25. The use of an oxygen sensor for measuring oxygen content in technical gases,
said oxygen sensor comprising a membrane substantially made of stabilized zirconium dioxide in the shape of a first tube and located at least partially within a second tube,
said membrane having a first internal side and a second external side, said first and second sides of the membrane having a respective first and a second electrically conductive, catalytic coating,
wherein a porous, preferably ceramic coating is provided outermost, on top of at least one of the electrically conductive, catalytic coatings

26. An oxygen sensor comprising a membrane in the form of a first tube, which is substantially made of stabilized zirconium dioxide, and which is located, at least partially, within a second tube, made of a gas tight material, the first tube having a first electrically conductive, catalytic coating on the internal side of the tube and a second electrically conductive, catalytic coating on the external side of the tube, a porous, preferably ceramic coating being provided on the external electrically conductive, catalytic coating, wherein
the first tube and the second tube are cylindrical and are retained by a row of clamped together blocks and sealing o-rings,
at least one first block having a through bore with a diameter, substantially corresponding to the outside diameter of the first tube, at least one other block having a bore with a diameter, substantially corresponding to the outside diameter of the second tube, and a third block having a through bore with varied diameter, i.e. a first diameter, substantially corresponding to the outside diameter of the first tube, at one end, a second diameter, substantially corresponding to the outside diameter of the second tube, at the second end, and, between the first and the second end, a third diameter with a size between the first diameter and the second diameter, and
the bores having small diameter increases at the respective faces facing an adjacent block, and an o-ring being inserted in a cavity, which due to the diameter increase of the bores exists between a tube in question and two adjacent blocks.

27. An oxygen sensor according to claim 26, wherein the third block comprises three cylindrical bore sections, each with their own respective diameter.

28. An oxygen sensor according to any one of claims 26 or 27, wherein a fourth block with a through bore with diameter increases at both the faces facing the adjacent blocks is inserted between the third block and the first block and/or the second block, and in the respective cavities, which exist between a tube in question, the fourth block and the two adjacent blocks due to the diameter increase of the bores, o-rings are inserted, and in that in the internal face of the bore of the fourth block, facing the first or the second tube, at least one circumferential groove is provided.

29. An oxygen sensor according to claim 28, wherein the diameter increases are provided by means of chamfering.

30. An oxygen sensor according to claim 28, wherein channels for a flushing gas lead to the circumferential grooves.

31. An oxygen sensor according to claim 30, wherein at least part of the measuring gas is used as flushing gas after having passed a gap between the first and the second tube.

32. An oxygen sensor according to claim 26, wherein the second tube is made of gas tight ceramics.
